(19) United States
(12) Patent Application Publication
(10) Pub. No.: US 2008/0210511 A1
(43) Pub. Date: Sep. 4, 2008

(54) Switchable Clutch with Low Control Power Requirement

(75) Inventors: Martin-Peter Bolz, Buehl (DE); Hartmut Krueger, Buehlertal (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/915,861

(22) PCT Filed: Aug. 8, 2006
(86) PCT No.: PCT/EP2006/065141

§ 371 Date: Nov. 29, 2007

(30) Foreign Application Priority Data
Sep. 1, 2005 (DE) 102005041461.3

(51) Int. Cl. F16D 13/00

(52) U.S. Cl. 192/70.3

(57) ABSTRACT

The invention relates to a switchable clutch which requires control power merely for switching from one operating state to another. The clutch is particularly suitable for connecting and disconnecting auxiliary units in internal combustion engines and motor vehicles. The clutch according to the invention has a driving element (9), which is rotationally fixed to a shaft (3) and a clutch disk (5) which is operatively connected to the auxiliary unit, at least one toggle lever (23) being rotatably mounted on the driving element (9), axial displacement of a control sleeve (33) causing it to engage with a first end (29) of the toggle lever (23) so that a second end (29) of the toggle lever (23), as a function of the position of the control sleeve (33), becomes operatively connected to the clutch disk (5), thereby closing or opening the clutch.

### BACKGROUND OF THE INVENTION

The invention relates to a clutch, in particular also a multi-plate clutch.

Clutches as well as multi-plate clutches have long been known from the prior art. They make it possible to transmit high torques in a small space at a low cost. Frequently, these types of clutches are closed by so-called clutch springs so that a torque can be transmitted between a clutch basket and the driving element. Opening the clutch is accomplished against the closing force of the clutch springs and consequently requires a relatively great expenditure of force. This force must be overcome as long as the clutch is supposed to be opened. This type of actuation of a clutch and in particular the design as a multi-plate clutch is known from motor vehicle technology for example and has been proven in order to optionally open or close the connection between an internal combustion engine and a gear.

This kind of actuation is disadvantageous if the times when the clutch is supposed to be open are relatively great and the clutch is also supposed to be actuated by an actuator. In this case, the actuator must overcome the closing force of the clutch during the entire time when the clutch is opened, something which produces a relatively large demand for energy.

With some auxiliary units in an internal combustion engine, such as the compressor of an air conditioner for example, the operating times of the auxiliary unit are very much lower than the operating times of the internal combustion engine.

### SUMMARY OF THE INVENTION

The invention is based on the objective of providing a switchable clutch, which requires only low energy for its actuation and despite this is able to transmit high torques.

This objective is attained by the clutch in accordance with the invention for switching an auxiliary unit in an internal combustion engine in that at least one toggle lever is rotatably mounted on a driving element, which toggle lever becomes operatively connected to a clutch basket through axial displacement of a control sleeve, thereby closing or opening the clutch.

It is possible via a control sleeve with two cylindrical control sections in connection with the toggle lever(s) to apply the required application force between the one driving element and a clutch basket without the actuator having to continuously exert a force on the control sleeve. As a result, the energy demand of the actuator with a closed clutch is reduced to zero.

In addition, it is possible via axial displacement of the control sleeve to reduce the closing force exerted by the toggle lever on the driving element or the clutch basket to zero so that the clutch in accordance with the invention opens. As a result, the energy demand of the actuator with an opened clutch is also reduced to zero.

In the case of the clutch in accordance with the invention, this means that the actuator needs energy merely during the switchover from the closed, i.e., from the coupled state, to the opened state and vice versa so that the overall energy consumption is only a function of the number of shifting operations and is therefore much lower than is the case with conventional clutches.

Because of its simple mechanical structure, the clutch in accordance with the invention is suitable for the most varied fields of application. In principle, it can be used in all fields of application in which conventional clutches and particularly multi-plate clutches are also used.

Another advantageous embodiment of the invention provides for the transition between the first cylindrical control section and the second cylindrical control section to be embodied as a truncated cone.

Through the selection of the angle of the cone, in one respect the path around which the control sleeve must be displaced can be adjusted in order to achieve a switchover of the clutch. At the same time, this determines the force that must be applied by the actuator.

In principle, the clutch in accordance with the invention can be actuated by any actuators, however, pneumatic or hydraulic actuators have proven to be particularly advantageous.

An especially advantageous embodiment of the invention provides that the control sleeve is guided tightly into the driving element, that a first fore part of the control sleeve delimits a first work chamber, and that a second fore part of the control sleeve delimits a second work chamber.

As a result, reciprocally filling the first work chamber and the second work chamber with a fluid under pressure, such as compressed air or a hydraulic fluid, makes it possible to displace the control sleeve in the axial direction and thereby open and close the clutch in accordance with the invention.

Of course, an electrical actuator can also be provided as an alternative.

In order to integrate the clutch in accordance with the invention into an existing system in the best possible manner, according to the invention, the outer diameter of the clutch basket clutch can be embodied as a belt pulley or have toothing. Another advantageous embodiment of the invention further provides that the driving element is connected in a rotationally fixed manner to a shaft, in particular a shaft of a refrigerant compressor of an air conditioner.

The clutch in accordance with the invention can be embodied in an advantageous manner as a multi-plate clutch. The clutch basket and at least one driving element of the multi-plate clutch are then embodied such that at least one outer plate is connected in a rotationally fixed and axially displaceable manner to the clutch basket, and at least one inner plate is connected in a rotationally fixed and axially displaceable manner to the driving element.

Additional advantages and advantageous embodiments of the invention can be found in the drawing, its description and the patent claims. All features described in the drawing, its description and the patent claims can be essential for the invention both individually as well as in any combination with one another.

### BRIEF DESCRIPTION OF THE DRAWING

The single drawing shows an isometric depiction of a clutch in accordance with the invention in the embodiment of a multi-plate clutch in section.

### DETAILED DESCRIPTION

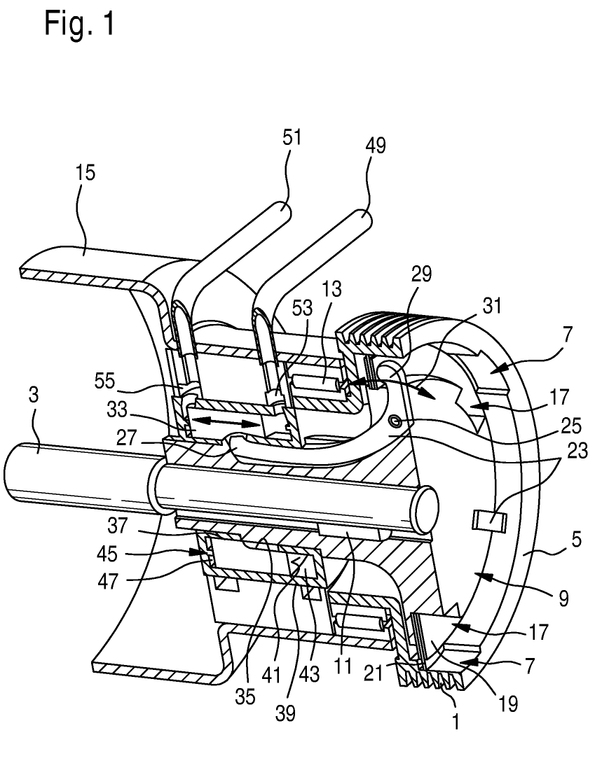

FIG. 1 depicts an exemplary embodiment of a section of a clutch in accordance with the invention. This embodiment is a multi-plate clutch. However, the invention is not limited to the embodiment of a multi-plate clutch. The clutch control in accordance with the invention is directly transferable in a corresponding manner to other clutch principles. The clutch in accordance with the invention shown in FIG. 1 is used to transfer torque between a belt pulley 1 and a shaft 3 as needed.

The inside of the belt pulley 1 is embodied as a clutch basket. For this purpose, axial grooves 7 that are distributed uniformly over the circumference are incorporated into the clutch basket 5. In this case, the clutch basket assumes, in a manner that is still to be described, the function of a clutch disk. In principle, the clutch basket can also have the shape of a disk, however.

The clutch basket 5 or the belt pulley 1 is rotatably mounted in a housing 15 by means of a roller bearing 13. The housing 15 can, for example, be part of an air conditioner compressor of a motor vehicle air conditioner.

Arranged in the interior of the clutch basket 5 is a driving element 9, which is connected to the shaft 3 in a rotationally fixed manner with the aid of a feather key 11. Several axial grooves 17 distributed over the circumference are incorporated into the driving element 9.

Inner plates 19 and outer plates 21 (only a few of which are shown in the FIGURE) are arranged between the clutch basket 5 and the driving element 9 in the embodiment of the clutch in accordance with the invention as a multi-plate clutch. The inner plates 19 have projections on their inside diameter, which engage in the axial grooves 17 of the driving elements 9, while the outer plates 21 have projections on their outside diameter, which cooperate with the axial grooves 7 in the clutch basket 5. This structure of a multi-plate clutch is sufficiently known making it possible to dispense with a detailed description.

As long as no application force exerted in the axial direction is acting between the inner plates 19 and the outer plates 21, the clutch is opened, i.e., no torque is being transmitted by the clutch basket 5 to the driving element 9. In the case of conventional multi-plate clutches, the application force required to close the clutch is applied by compression springs.

In the case of the clutch in accordance with the invention, several toggle levers 23 distributed over the circumference are provided for this purpose. The toggle levers 23 are each rotatably mounted around a rotation point 25, only one of which is visible in FIG. 1. In the arrangement depicted in FIG. 1, the clutch can be closed by the first end 27 of the toggle levers 23 being moved in the direction of the shaft 3. If, namely, the first end 27 of the toggle lever 23 is moved in the direction of the shaft 3, the toggle lever 23 rotates around the rotation point 25 so that a second end 29 of the toggle lever 23 presses the inner plates 19 and the outer plates 21 together, thereby making the transmission of torque between the clutch basket and the driving element 9 possible.

In order to execute the required rotational movement of the toggle lever 23, the clutch in accordance with the invention is provided with a control sleeve 33, which is guided displaceably in the axial direction at least indirectly onto the driving element 9. The control sleeve 33 has, on its inside diameter, a first cylindrical control section 35 and a second cylindrical control section 37. A transition (no reference number) in the shape of a truncated cone is provided between a first cylindrical control section 35 and a second cylindrical control section 37.

The position of the control sleeve 33 shown in FIG. 1 is the first end 27 of the toggle lever 23 engaged with the first control section 35 of the control sleeve 33. In this position, the second end 29 of the toggle lever 23 does not exert any force in the axial direction of the inner plates 19 and the outer plates 21 such that clutch is opened.

If the control sleeve 33 is now moved to the right with respect to the position shown in FIG. 1, i.e., in the direction of the clutch basket 5, the contract surface between the first end 27 of the toggle lever 23 moves over the truncated-cone-shaped transition to the second cylindrical control section 37. Since the diameter of the second cylindrical control section 37 is smaller than that of the first control section 35, the toggle lever 23 is thereby actuated and executes a counterclockwise rotation. As a result of this, the second end 29 of the toggle lever 23 presses the inner plates 19 and the outer plates 21 against each other and the clutch is closed.

By appropriately coordinating the deflection resistance of the toggle lever 23 and the inner contour of the control sleeve 33, the axial force acting on the inner plates 19 and the outer plates 21 can be adjusted with a closed clutch.

Since the restoring force exerted by the first end 27 of the toggle lever 23 on control sections 35 or 37 essentially runs perpendicular to the surface of the control sections 35 and 37, this restoring force does not produce an axial displacement of the control sleeve 33, so that without outside effort it remains in the position in which it was put by an actuator.

In the case of the depicted clutch in accordance with the invention, the control sleeve 33 is actuated with the aid of compressed air. For this purpose, the control sleeve 33 is arranged tightly and axially displaceably in a housing 39, which, in turn, is connected in a rotationally fixed manner to the driving element 9. The housing 39 and a first fore part 41 of the control sleeve 33 delimits a first work chamber 43. A second fore part 45 of the control sleeve 33 delimits a second work chamber 47 in a corresponding manner.

A first connection 49 and a second compressed air connection 51 are provided on the housing 15, and said connections supply the second work chamber 47 or the first work chamber 43 with compressed air via a first ring channel 53 and a second ring channel 55. The stationary ring channels 53 and 55 make the compressed air supply of the work chambers 43 and 47 possible, which, just like the housing 39, are rotating along with the driving element 9.

When the first compressed air connection 49 is acted upon with compressed air, the pressure rises in the first work chamber 43 and the control sleeve 33 moves to the left into the position depicted in FIG. 1. As a result of this, the clutch opens.

As soon as the clutch is opened, the first compressed air connection 49 can be switched to a depressurized state again since the clutch in accordance with the invention does not change its switching state by itself.

If the clutch is supposed to be closed, the second compressed air connection 51 is acted upon with pressure so that compressed air reaches the second work chamber 47 and the control sleeve 33 moves to the right.

Especially advantageous in the actuation of the clutch using compressed air is, among other things, that the unavoidable leaks do not have any detrimental effects on the environment and therefore it is not necessary to take any special precautions for draining off the leaks.

The device in accordance with the invention is not restricted to the design of a multi-plate clutch.

1. Clutch for connecting and/or disconnecting a unit, to a driving element (9), which is connected in a rotationally fixed manner to a shaft (3), and a clutch disk (5), which is operatively connected to the auxiliary unit, characterized in that at least one toggle lever (23) is rotatably mounted on the driving element (9), wherein axial displacement of a control sleeve (33) causes it to engage with a first end (27) of the toggle lever (23) so that a second end (29) of the toggle lever (23), as a function of the position of the control sleeve (33), becomes operatively connected to the clutch disk (5), thereby closing or opening the clutch.

2. Clutch according to claim 1, characterized in that the control sleeve (33) can be displaced in the axial direction relative to the driving element (9) by an actuator.

3. Clutch according to claim 2, characterized in that the actuator is a pneumatic or a hydraulic actuator.

4. Clutch according to claim 2, characterized in that the actuator is an electrical actuator.

5. Clutch according to claim 1, characterized in that the control sleeve (33) has a first control section (35) and a second control section (37), wherein axial displacement of the control sleeve (33) causes the first control section (35) or the second control section (37) to engage with a first end (27) of the toggle lever (23).

6. Clutch according to claim 5, characterized in that the transition between the first control section (35) and the second control section (37) is embodied as a truncated cone.

7. Clutch according to claim 5, characterized in that the control sleeve (33) is embodied cylindrically or coaxially to a longitudinal axis of the driving element (9) in the area of the first control section (35) and/or of the second control section (37).

8. Clutch according to claim 1, characterized in that the control sleeve (33) is guided tightly into the driving element (9) or a housing (39) fastened to the driving element (9).

9. Clutch according to claim 1, characterized in that the first fore part (41) of the control sleeve (33) delimits a first work chamber (43), and that a second fore part (45) of the control sleeve (33) delimits a second work chamber (47).

10. Clutch according to claim 9, characterized in that the first work chamber (43) connected at least indirectly to a first connection (49), that the second work chamber (47) is connected at least indirectly to a second connection (51).

11. Clutch according to claim 10, characterized in that the first connection (49) and the second connection (51) are fluid connections.

12. Clutch according to claim 1, characterized in that the driving element (9) is connected in a rotationally fixed manner to a shaft (3) of an auxiliary unit in an internal combustion engine of a motor vehicle.

13. Clutch according to claim 1, characterized in that the clutch disk is embodied as a clutch basket (5), which is embodied as a belt pulley (1) on its outer diameter.

14. Clutch according to claim 1, characterized in that the clutch is embodied as a multi-plate clutch, with at least one outer plate (21) and at least one inner plate (19), wherein at least one outer plate (21) is connected in a rotationally fixed and axially displaceable manner to the clutch disk (5), and at least one inner plate (19) is connected in a rotationally fixed and axially displaceable manner to the driving element (9).

15. Clutch according to claim 14, characterized in that at least one toggle lever (23) is rotatably mounted on the driving element (9), that a control sleeve (33) is arranged axially displaceably on the driving element (9), that the control sleeve (33) has a first control section (35) and a second control section (37), that axial displacement of the control sleeve (33) causes the first control section (35) or the second control section (37) to engage with a first end (27) of the toggle lever (23), and that a second end (29) of the toggle lever (23) opens or closes the multi-plate clutch as a function of the position of the control sleeve (33)

16. Clutch according to claim 1, wherein the unit is an auxiliary unit in an internal combustion engine.

17. Clutch according to claim 12, wherein the shaft (3) is a shaft of a refrigerant compressor of an air conditioner.
